(19) United States
(12) Patent Application Publication
(10) Pub. No.: US 2025/0383590 A1
(43) Pub. Date: Dec. 18, 2025

(54) Rechargeable Photography Support Device

(71) Applicant: PGYTECH CO.,LTD, Jiangsu (CN)

(72) Inventors: Liang ZHU, Jiangsu (CN); Chaohao PAN, Hubei (CN)

(73) Assignee: PGYTECH CO.,LTD, Jiangsu (CN)

(21) Appl. No.: 18/741,131

(22) Filed: Jun. 12, 2024

(51) Int. Cl. G03B 17/56; F16M 13/00; F16M 13/04; F16M 13/06; H02J 7/00; H02J 50/10; H02J 50/90

(52) U.S. Cl. CPC G03B 17/561; F16M 13/005; F16M 13/04; F16M 13/06; G03B 17/563; H02J 7/0044; H02J 50/10; H02J 50/90

(57) ABSTRACT

A rechargeable photography support device comprises a bracket and a handle which is separated from the bracket. The handle is provided with a first assembly part, the bracket is provided with a second assembly part, and the first assembly part and the second assembly part are detachably connected, and the bracket and the handle are respectively provided with a power supply part and a wireless charging part.

### TECHNICAL FIELD

The present invention relates to the technical field of photographic handles, in particular to a rechargeable photography support device.

### BACKGROUND

With the advent of the electronic age, more and more people like to record the beautiful moments in their lives through photography. In the prior art, in addition to the electronic equipment itself, in order to better adjust and facilitate the user's use, the electronic equipment will also use the handle for auxiliary photography to improve the user's experience.

However, the existing handle has a complicated structure, especially the integrated structure, which makes it occupy a large space and has limited application scenarios. Moreover, electronic equipment cannot be charged well during use, which causes a lot of inconvenience in use.

For example, the US patent No. US20150237251A1 discloses a “HANDLE FOR HANDHELD TERMINAL”, which adopts an integrated structure, occupies a large space, has limited application scenarios, and cannot charge electronic equipment well in use.

Therefore, it is necessary to put forward a new type of handle, which consists of a handle and a bracket, and the handle and the bracket can be detached, occupying a small space. When the bracket is detached from the handle, the bracket can support the photographic equipment independently. When the bracket is connected with the handle, the wireless charging part in the bracket can be electrified and wirelessly charge the photographic equipment, therefore the charging is simple and convenient.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a rechargeable photography support device to solve the problems that the existing photographic handle with an integrated structure cannot be disassembled and the photographic equipment is inconvenient to charge.

In order to achieve the above object, the present invention adopts the following technical solution:

A rechargeable photography support device includes a bracket and a handle separated from the bracket;
the handle is provided with a first assembly part, and the bracket is provided with a second assembly part; and
the first assembly part is detachably connected with the second assembly part; and
the bracket and the handle are respectively provided with a power supply part and a wireless charging part.

A rechargeable photography support device includes a bracket and a handle separated from the bracket;
the handle is partially depressed and forms a dovetail groove, one end of the bracket is provided with at least two dovetail inclined planes, and the end of the bracket with the dovetail inclined planes is inserted into the dovetail groove; and
a movable locking tongue is arranged in the handle, and both ends of the locking tongue are respectively provided with a clamping part and a pushing part; the pushing part is used for driving the clamping part to move, the clamping part is located within the dovetail groove, and a locking tongue groove matched with the clamping part is formed on one side of the bracket; and
the bracket and the handle are respectively provided with a power supply part and a wireless charging part.

A method for supporting photographic equipment includes adopting a rechargeable photography supporting device, which comprises a bracket and a handle separated from the bracket; wherein the handle is provided with a first assembly part, and the bracket is provided with a second assembly par; the first assembly part is a dovetail groove, the second assembly part is a dovetail inclined plane, and the bracket and the handle are respectively provided with a power supply part and a wireless charging part; and a bottom of the dovetail groove is provided with a first connector; one end of the bracket inserted into the dovetail groove is provided with a second connector, one side of the bracket facing the handle is provided with a locking tongue groove, a locking tongue is rotatably connected in the handle, one end of the locking tongue penetrates into the dovetail groove and is arranged as a clamping part, and the other end of the locking tongue penetrates out of the handle and is arranged as a pushing part; and
the method includes the following steps:
Step 1, connecting the bracket and the handle by matching the first assembly part and the second assembly part; and
Step 2, attaching the photographic equipment to the surface of the bracket and fixing the photographic equipment; and
Step 3, wirelessly charging the photographic equipment by using the wireless charging part; and
Step 4, grabbing the handle and shooting with the photographic equipment.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic structural diagram of the whole invention.

FIG. 2 is a schematic structural view of the whole invention from another perspective.

FIG. 3 is a schematic structural view of the handle of the present invention.

FIG. 4 is a schematic view of the handle of the present invention from another perspective.

FIG. 5 is a schematic structural view of the stent of the present invention.

FIG. 6 is a schematic structural view of the stent of the present invention from another perspective.

FIG. 7 is a schematic diagram of the internal structure of the stent of the present invention.

FIG. 8 is a sectional view of the whole invention.

FIG. 9 is a state diagram when the handle of FIG. 8 is separated from the bracket.

FIG. 10 is a state diagram of the present invention when supporting a mobile phone.

FIG. 11 is a state diagram when the bracket of the present invention supports the mobile phone.

In the figures: Handle (100); Dovetail groove (101); First connector (102); Hand-held part (103); Bracket (200); Dovetail inclined plane (201); Second connector (202); Locking tongue groove (203); Magnet group (204); Wireless charging coil (205); Support (206); Bearing surface (207); Locking tongue (300); Clamping part (301); Pushing part (302); Storage battery (400).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

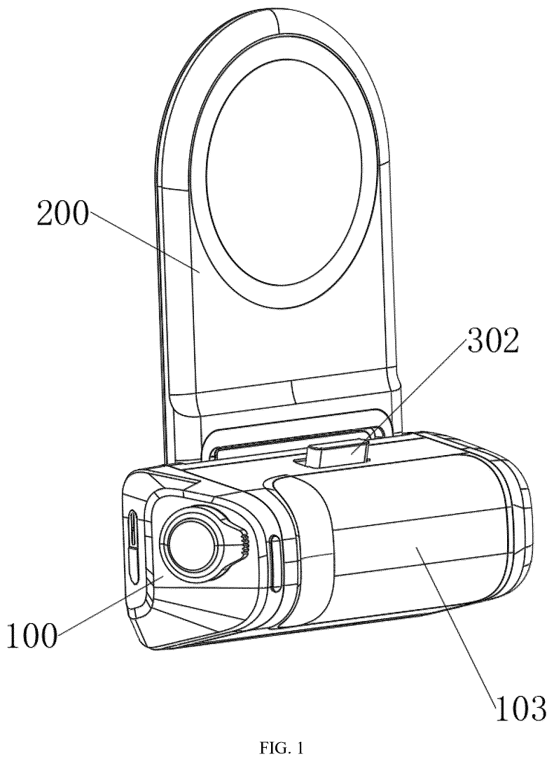

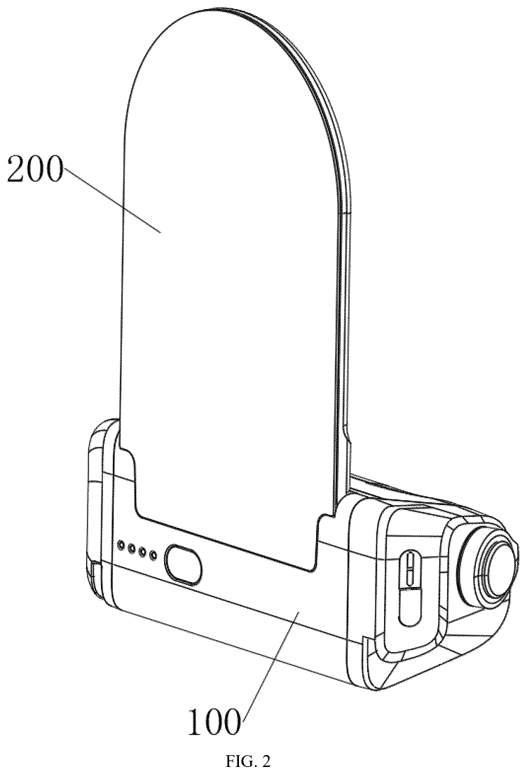

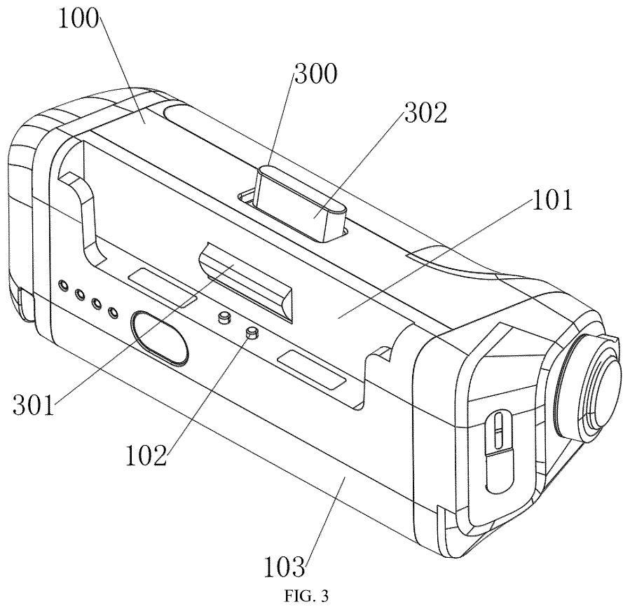

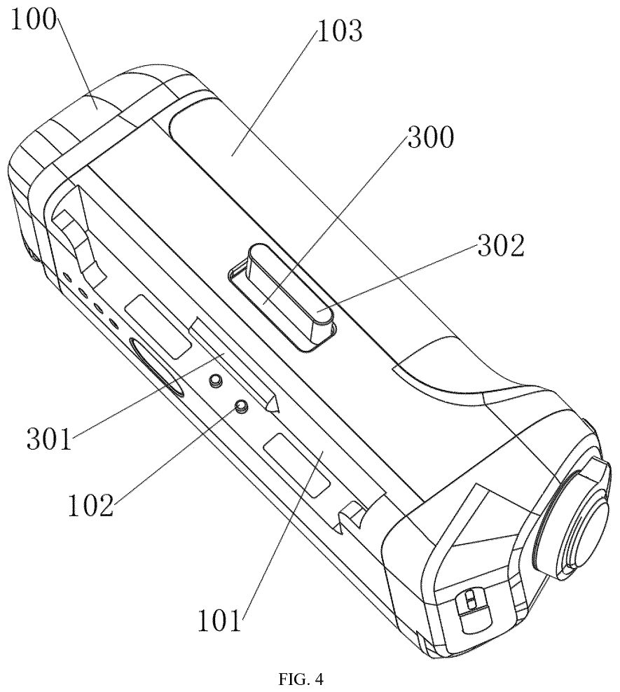

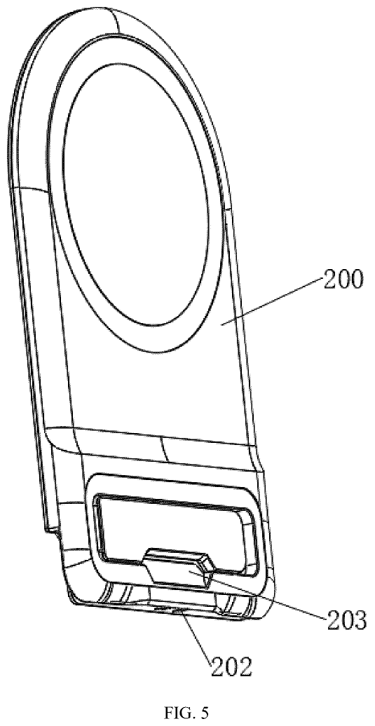

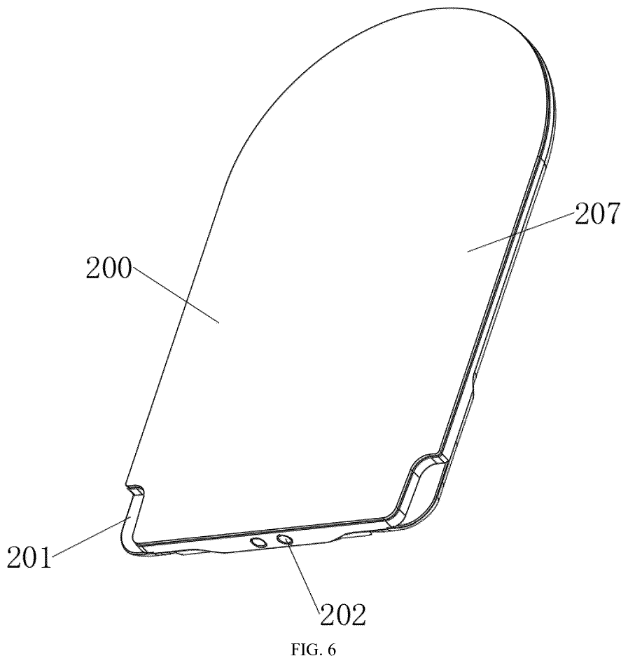

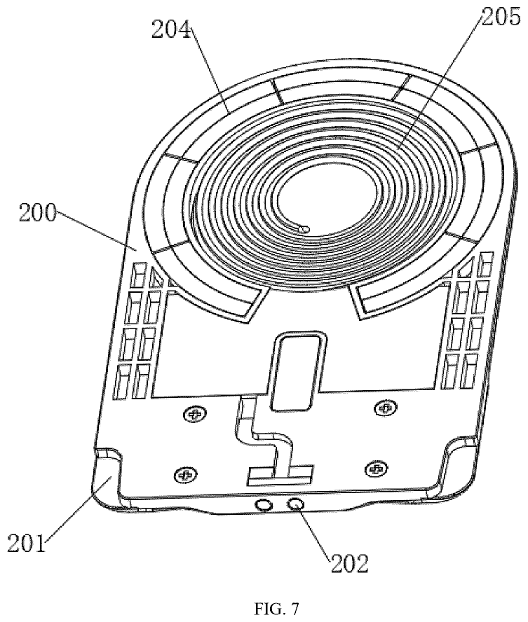

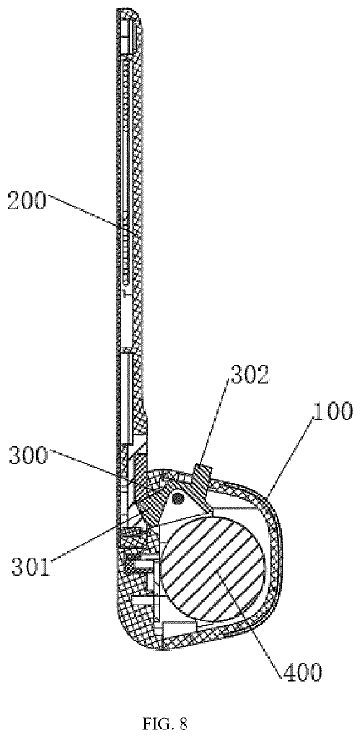

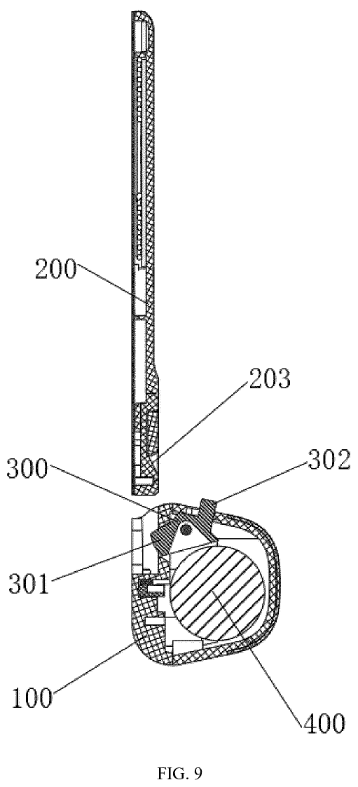

Please refer to FIG. 1 to FIG. 10.

The present invention provides a rechargeable photography support device, which includes a bracket 200 and a handle 100 separated from the bracket 200, wherein the handle 100 is provided with a first assembly part, the bracket 200 is provided with a second assembly part, the first assembly part and the second assembly part are detachably connected, and the bracket 200 and the handle 100 are respectively provided with a power supply part and a wireless charging part.

In this embodiment, the first assembly part is a dovetail groove 101, and the dovetail groove 101 is concavely arranged on the outer surface of the handle 100, and the second assembly part is a dovetail inclined plane 201; there are at least two dovetail inclined planes 201, both of which are provided at the end of the bracket 200 facing the first assembly part. When the first assembly part is connected with the second assembly part, the two dovetail inclined planes 201 are respectively inserted into the two ends of the dovetail groove 101.

When the bracket 200 needs to be installed on the handle 100, it is only necessary to insert the end of the bracket 200 with the dovetail inclined plane 201 along the opening direction of the dovetail groove 101 until it completely enters and is fixed in the dovetail groove 101. This connection method utilizes the matching between the dovetail inclined plane 201 and the dovetail groove 101, and realizes the stable connection between the bracket 200 and the handle 100 through the interaction between the inclined plane and the groove. At the same time, due to the special shape of dovetail groove 101, bracket 200 is not likely to loosen or fall off after insertion, which ensures the stability and reliability of connection.

When the bracket 200 needs to be disassembled, the user only needs to pull the bracket 200 out of the dovetail groove 101 in the opposite direction. This detachable connection mode makes it convenient to disassemble and assemble the bracket 200 and the handle 100, thus providing greater flexibility for the user.

In terms of carrying, by detaching the bracket 200 from the handle 100, the overall occupied area and weight can be significantly reduced, making it more convenient to carry, which is undoubtedly an important advantage for users who need to move or carry equipment frequently.

In other embodiments (not shown in the attached drawings), the detachable connection between the bracket 200 and the handle 100 can also be snap connection, screw connection and any other way that can realize the detachable connection;

For example, when the bracket 200 and the handle 100 are connected by clamping, the first mating part and the second mating part are respectively configured as clamping structures that can cooperate with each other, such as buckles, claws or the like.

When the bracket 200 and the handle 100 are connected by threaded connection, the first mating part and the second mating part are respectively configured as threaded connection structures that can cooperate with each other, such as external threads and internal threads.

In this embodiment, a locking tongue 300 is rotatably connected in the handle 100. One end of the locking tongue 300 penetrates into the dovetail groove 101 and is set as a clamping part 301, while the other end of the locking tongue 300 penetrates out of the handle 100 and is set as a pushing part 302. A side of the bracket 200 facing the handle 100 is provided with a locking tongue groove 203. When the first assembly part is connected with the second assembly part, the clamping part 301 of the locking tongue 300 is inserted into the locking tongue groove 203.

The handle 100 is provided with a space for the locking tongue 300, the clamping part 301 and the pushing part 302 to move, and a torsion spring is arranged at the rotating connector of the locking tongue 300 and the handle 100, so that the whole locking tongue 300 and the clamping part 301 can be driven to rotate by pushing the pushing part 302; and by arranging the torsion spring at the rotating part, when the locking tongue 300 is pushed to rotate, the torsion spring will be twisted and generate elastic force, so that when the locking tongue 300 is removed by the applied external force, the torsion spring will push the locking tongue 300 to rotate and reset by the resilience.

Therefore, before the bracket 200 is connected with the handle 100 through the matching of the dovetail inclined plane 201 and the dovetail groove 101, the pushing part 302 is first moved to push the locking tongue 300 to rotate, and when the locking tongue 300 rotates, the clamping part 301 will shrink into the handle 100, so that the bracket 200 can be smoothly inserted into the dovetail groove 101.

When the bracket 200 is completely inserted into the dovetail groove 101, the pushing part 302 is released, and then the locking tongue 300 automatically rotates and resets by the elastic force of the torsion spring. At the same time, the clamping part 301 extends from the handle 100 and is inserted into the locking tongue groove 203, so that the bracket 200 can be limited in the up-and-down direction through the cooperation of the clamping part 301 and the locking tongue groove 203, so that the bracket 200 cannot be pulled out of the dovetail groove 101, otherwise, when the bracket 200 needs to be detached from the handle 100, it is only necessary to retract the clamping part 301 back into the handle 100.

In other embodiments (not shown in the attached drawings), the locking tongue 300 can also be installed on the handle 100 in a sliding way, so that the clamping part 301 can slide in or out of the dovetail groove 101. When the clamping part 301 slides into the dovetail groove 101, it will engage with the locking tongue groove 203, otherwise it will disengage from the engaging part.

In this embodiment, a first connector 102 is installed at the bottom of the dovetail groove 101, and a second connector 202 is installed at one end of the bracket 200 inserted into the dovetail groove 101. The first connector 102 and the second connector 202 are a male connector and a female connector respectively. When the first assembly part is connected with the second assembly part, the first connector 102 and the second connector 202 are connected, and the side of the bracket 200 facing away from the handle 100 is set as a bearing surface.

The bearing surface 207 is relatively flat and used for bearing photographic equipment. The outer periphery of the handle 100 is set as the hand-held part 103, and the power supply part is the storage battery 400, which is installed in the handle 100 and electrically connected with the first connector 102. The wireless charging part is a wireless charging coil 205, which is installed in the bracket 200 and electrically connected with the second connector 202. Inside the bracket 200, a magnet group 204 surrounding the outside of the wireless charging coil 205 is installed.

The handle 100 can be grasped by holding the hand-held part 103, the storage battery 400 is provided with a charging port penetrating through the handle 100, and the storage battery 400 can be charged through the charging port; the wireless charging coil 205 is equipped with a wireless charging chip, which can be adapted to photographic equipment with wireless charging function; when the bracket 200 is installed on the handle 100, the first connector 102 will communicate with the second connector 202;
wherein the storage battery 400 is a device for providing electric energy, which is connected with the second connector 202 on the handle 100 through the first connector 102. This connection mode allows the storage battery 400 to provide electric power for the wireless charging coil 205 on the bracket 200, and the parameters such as the capacity and voltage of the storage battery 400 should be reasonably selected according to the charging requirements of the photographic equipment.

According to the above, the electrified wireless charging coil 205 will generate an electromagnetic field, which interacts with a wireless charging receiver in the photographic equipment to wirelessly transmit electric energy to the photographic equipment, so that the user can charge the photographic equipment very conveniently without using the traditional charging cable and adapter.

The power supply part is not limited to the storage battery 400, but in other embodiments, the power supply part can also be a power connection mechanism with wires, in which the power connection mechanism is a device that can be connected with an external power supply, which is usually equipped with wires for transmitting electric energy from the external power supply to the inside of the equipment. When in use, users only need to connect the wires of the power connection mechanism with the external power supply (such as a wall socket, a mobile power supply, a car charger, etc.), so that the external power supply can be realized as a power connection mechanism.

Therefore, once the power connection mechanism is connected with the external power supply and gets power supply, it will transfer the power to the wireless charging coil 205 through the internal circuit system. The wireless charging coil 205 is a key component in the equipment to realize the wireless charging function, and it can receive the electric energy from the power receiving mechanism and wirelessly transmit the electric energy to the equipment that needs charging through the electromagnetic induction principle.

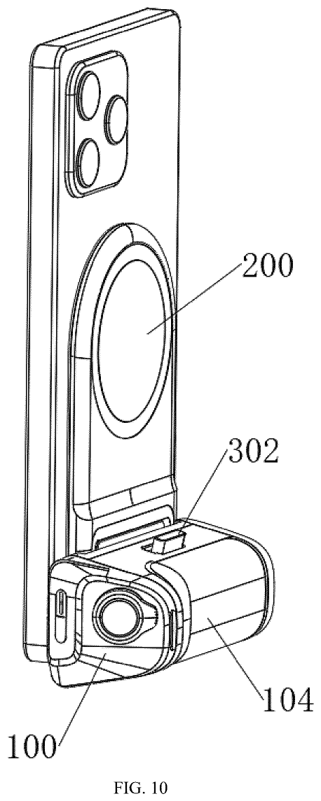

In this example, the bearing surface 207 can be attached to photographic equipment, such as a mobile phone, as shown in FIG. 10. At the same time, a magnet should be arranged on the side where the photographic equipment is in contact with the bearing surface 207, so that the photographic equipment can be adsorbed on the bracket 200 through the cooperation between the magnet of the photographic equipment and the magnet group 204, so that the bracket 200 can be quickly fixed on the bracket 200.

In other embodiments (not shown in the attached drawings), the bracket 200 can also be installed on the bracket 200 by clamping mechanism or screw connection.

According to the above, when fixing by clamping, the clamping mechanism can be designed to match the bracket 200 and the parts or structures to be installed, so as to ensure stable and firm connection, and the clamping mechanism can be adjusted manually or automatically to adapt to parts with different sizes or shapes; When screw connection is adopted, threaded holes or through holes can be preset on the bracket 200, so that the screws can pass through these holes and be screwed into the corresponding threaded holes in the parts or structures to be installed, wherein the screw connection provides strong connection force and stability, and is suitable for photographic equipment that needs to bear heavy load or vibration; in addition to clamping and screw connection, there are many other connection methods that can be used to install the bracket 200, such as bonding, suction cups, etc., and which connection method to choose depends on the specific application requirements, environmental conditions and costs.

Then, after the bracket 200 is installed on the handle 100, the photographic equipment with wireless charging function is installed on the bracket 200, so that the storage battery 400 can supply power to the wireless charging coil 205 through the connection of the first connector 102 and the second connector 202, and then the electrified wireless charging coil 205 wirelessly charges the photographic equipment, so that the photographic equipment can be charged very conveniently in this way.

According to the above, the side of the bracket 200 facing the handle 100 is also rotatably connected with a support 206, and the support 206 can be turned and folded. When the support 206 is folded, the support rod is attached to the surface of the bracket 200, so that when the bracket 200 is connected with the handle 100, the support 206 may be closely attached to the bracket 200 to reduce the overall volume and facilitate carrying.

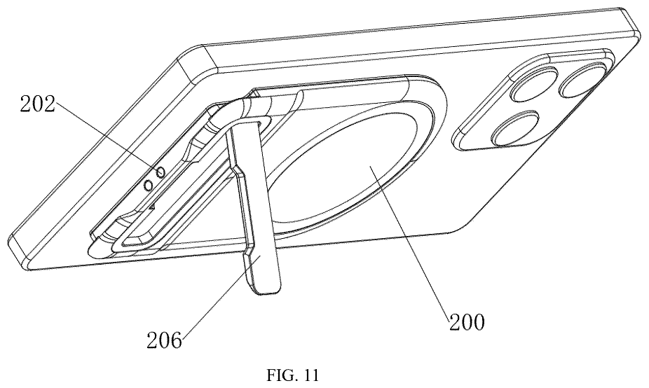

However, when the bracket 200 needs to be detached from the handle 100 and used to support the photographic equipment alone, the support 206 can play its unique role as follows:
the overturning action enables the support 206 to change from a position close attaching to the bracket to a position at an angle with the bracket, thus forming a stable support structure;
thus, when the support 206 is turned in place, a stable triangular support structure will be formed among the bracket 200, the support 206 and the photographic equipment, which can ensure that the photographic equipment remains stable on a flat plane and is not easy to fall or slide, as shown in FIG. 11;
in order to further improve the stability of the support structure, anti-skid design, such as rubber pad or texture design, can be added to the bottom of the support 206; these anti-skid measures can increase the friction between the support and the plane and prevent the photographic equipment from sliding or moving during the placing process.

In other embodiments, the side of the bracket 200 provided with the support 206 can also be provided with a receiving groove, and the support 206 is rotatably arranged in the receiving groove, and the size and shape of the receiving groove are matched with those of the support 206, so that the support 206 can be received in the receiving groove when the support 206 is not used, which makes the surface of the bracket 200 smoother and the user experience be improved.

The present invention further provides a method for supporting photographic equipment, which includes that following steps: adopting a rechargeable photography support device which includes a bracket 200 and a handle 100 which is separated from the bracket 200, wherein the handle 100 is provided with a first assembly part, and the bracket 200 is provided with a second assembly part, wherein the first assembly part is a dovetail groove 101, and the second assembly part is a dovetail inclined plane 201; the bracket 200 and the handle 100 are respectively provided with a power supply part and a wireless charging part; the bottom of the dovetail groove 101 is provided with a first connector 102; one end of the bracket 200 inserted into the dovetail groove 101 is provided with a second connector 202; one side of the bracket 200 facing the handle 100 is provided with a locking tongue groove 203; a locking tongue 300 is rotatably connected in the handle 100; one end of the locking tongue 300 penetrates into the dovetail groove 101 and is set as a clamping part 301, and the other end of the locking tongue 300 penetrates through the handle 100 and is set as a pushing part 302;
the method comprises the following steps:
Step 1, the bracket 200 and the handle 100 are connected through the matching of the first assembly part and the second assembly part; when the bracket 200 is connected with the handle 100, one end of the bracket 200 with the dovetail inclined plane 201 is inserted into the dovetail groove 101 of the handle 100; before the bracket 200 is inserted into the handle 100, the pushing part 302 of the locking tongue 300 is pushed to rotate, so that the clamping part 301 of the locking tongue 300 is retracted into the handle 100; when the bracket 200 is inserted into the handle 100, the pushing part 302 is released, and the locking tongue 300 is elastically restored, and at the same time, the clamping part 301 extends from the handle 100 and is inserted into the locking tongue groove 203, thereby fixing the bracket 200 and the handle 100; when the bracket 200 and the handle 100 are fixed, the first connector 102 is connected with the second connector 202, so that the wireless charging part is connected with the power supply part and electrified;
Step 2, the photographic equipment is attached to the surface of the bracket 200 and fixed;
Step 3, the photographic equipment is wirelessly charged by using a wireless charging part; when the photographic equipment is installed on the bracket 200, the wireless charging part after being powered on wirelessly charges the photographic equipment;
Step 4, the handle 100 is grasped and shooting is performed with the photographic equipment.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A rechargeable photography support device, comprising a bracket and a handle separated from the bracket;
wherein the handle is partially depressed and forms a dovetail groove, one end of the bracket is provided with at least two dovetail inclined planes, and the end of the bracket with the dovetail inclined planes is inserted into the dovetail groove; and
a movable locking tongue is arranged in the handle, and both ends of the locking tongue are respectively provided with a clamping part and a pushing part; the pushing part is used for driving the clamping part to move, the clamping part is located within the dovetail groove, and a locking tongue groove matched with the clamping part is formed on one side of the bracket; and
the bracket and the handle are respectively provided with a power supply part and a wireless charging part.

2. A rechargeable photography support device, comprising a bracket and a handle separated from the bracket;
wherein the handle is provided with a first assembly part, and the bracket is provided with a second assembly part; and
the first assembly part is detachably connected with the second assembly part; and
the bracket and the handle are respectively provided with a power supply part and a wireless charging part.

3. The rechargeable photography support device according to claim 2, wherein the first assembly part is a dovetail groove, and the dovetail groove is concavely arranged on an outer surface of the handle.

4. The rechargeable photography support device according to claim 3, wherein the second assembly part is a dovetail inclined plane, and the dovetail inclined plane is provided at least in two places, and both the dovetail inclined planes are provided at one end of the bracket facing the first assembly part.

5. The rechargeable photography support device according to claim 4, wherein when the first assembly part and the second assembly part are connected, the dovetail inclined planes at the two places are respectively inserted into the two ends of the dovetail groove.

6. The rechargeable photography support device according to claim 5, wherein a first connector is installed at the bottom of the dovetail groove, and a second connector is installed at one end of the bracket inserted into the dovetail groove.

7. The rechargeable photography support device according to claim 6, wherein the first connector and the second connector are a male connector and a female connector respectively, and when the first assembly part is connected with the second assembly part, the first connector and the second connector are connected.

8. The rechargeable photography support device according to claim 5, wherein a locking tongue is rotatably connected in the handle, one end of the locking tongue penetrates into the dovetail groove and is set as a clamping part, and the other end of the locking tongue penetrates out of the handle and is set as a pushing part.

9. The rechargeable photography support device according to claim 8, wherein one side of the bracket facing the handle is provided with a locking tongue groove, and when the first assembly part is connected with the second assembly part, the clamping part of the locking tongue is inserted into the locking tongue groove.

10. The rechargeable photography support device according to claim 9, wherein one side of the bracket facing away from the handle is set as a bearing surface, the bearing surface is relatively flat and used for bearing photographic equipment, and the periphery of the handle is set as a hand-held part.

11. The rechargeable photography support device according to claim 7, wherein the power supply part is a storage battery, the storage battery is installed in the handle, and the storage battery is electrically connected with the first connector.

12. The rechargeable photography support device according to claim 7, wherein the wireless charging part is a wireless charging coil, the wireless charging coil is installed inside the bracket, and the wireless charging coil is electrically connected with the second connector.

13. The rechargeable photography support device according to claim 12, wherein a magnet group surrounding the outside of the wireless charging coil is installed inside the bracket.

14. The rechargeable photography support device according to claim 9, wherein one side of the bracket facing the handle is also rotatably connected with a support, and the support can be turned and folded, and when the support is folded, the support rod is attached to a surface of the bracket.

15. A method for supporting photographic equipment, comprising adopting a rechargeable photography supporting device, which comprises a bracket and a handle separated from the bracket; wherein the handle is provided with a first assembly part, and the bracket is provided with a second assembly part; the first assembly part is a dovetail groove, the second assembly part is a dovetail inclined plane, and the bracket and the handle are respectively provided with a power supply part and a wireless charging part; and a bottom of the dovetail groove is provided with a first connector; one end of the bracket inserted into the dovetail groove is provided with a second connector, one side of the bracket facing the handle is provided with a locking tongue groove, a locking tongue is rotatably connected in the handle, one end of the locking tongue penetrates into the dovetail groove and is arranged as a clamping part, and the other end of the locking tongue penetrates out of the handle and is arranged as a pushing part; and
the method comprises the following steps:
Step 1, connecting the bracket and the handle by matching the first assembly part and the second assembly part; and
Step 2, attaching the photographic equipment to the surface of the bracket and fixing the photographic equipment; and
Step 3, wirelessly charging the photographic equipment by using the wireless charging part; and
Step 4, grabbing the handle and shooting with the photographic equipment.

16. The method for supporting photographic equipment according to claim 15, wherein when the bracket is connected with the handle, one end of the bracket with a dovetail inclined plane is inserted into the dovetail groove of the handle.

17. The method for supporting photographic equipment according to claim 16, wherein before the bracket is inserted into the handle, the pushing part of the locking tongue is pushed to rotate, so that the clamping part of the locking tongue is retracted into the handle.

18. The method for supporting photographic equipment according to claim 17, wherein after the bracket is inserted into the handle, the pushing part is released, and the locking tongue is rebounded and reset, and at the same time, the clamping part is extended from the handle and inserted into the locking tongue groove, thereby fixing the bracket and the handle.

19. The method for supporting photographic equipment according to claim 18, wherein after the bracket and the handle are fixed, the first connector is connected with the second connector, so that the wireless charging part is connected with the power supply part and electrified.

20. The method for supporting photographic equipment according to claim 19, wherein after the photographic equipment is installed on the bracket, the wireless charging part after being electrified wirelessly charges the photographic equipment.
